(19) United States
(12) Patent Application Publication
(10) Pub. No.: US 2008/0065561 A1
(43) Pub. Date: Mar. 13, 2008

(54) METHOD AND SYSTEM FOR COLLABORATIVE INVESTMENT, SAVING AND FINANCIAL PLANNING

(76) Inventors: Stephen A. Ethridge, Corte Madera, CA (US); Wallace A. Burns, Brandon, MS (US)

Correspondence Address: INTELLECTUAL PROPERTY LAW GROUP LLP, 12 SOUTH FIRST STREET, SUITE 1205, SAN JOSE, CA, 95113, US

(21) Appl. No.: 11/852,267

(22) Filed: Sep. 7, 2007

Related U.S. Application Data
(60) Provisional application No. 60/824,898, filed on Sep. 7, 2006.

(51) Int. Cl. G06Q 40/00

(52) U.S. Cl. 705/36 R

(57) ABSTRACT

A method and system for collaborative investment and financial planning between one or more investors/savers and one or more matchers/contributors utilizing a web-based system facilitator is described. In an embodiment of the present invention, the method and system enforces the collaborative investing plan between the investor and the plurality of matchers by immediate notification to all parties once any party fails to make the monthly contribution or the investor withdraws from one or more investment/saving vehicle accounts before the end of a predetermined time period. Matchers/contributors decide whether to discontinue or continue participation in the plan. A fund transfer mechanism is utilized in the method and system to facilitate fund transfer from investors and matchers to selected investment vehicle account(s). In an embodiment of the present invention, the method and system further transmits to the parties of the plan, messages providing investment updates and information on financial topics. All parties to the plan are educated in investment advice provided by the system.

### CROSS-REFERENCE TO RELATED APPLICATIONS

This application claims priority to U.S. provisional patent application no. 60/824,898, filed on Sep. 7, 2006, which is incorporated herein by reference.

### BACKGROUND OF THE INVENTION

1. Field of Invention

This invention relates to a method and system for collaborative investment/saving and financial planning between one or more investors and one or more matchers utilizing an automated system facilitator. Preferably the system facilitator would be web-based.

2. Background

Certain individuals, for example, the younger generation between the ages of 15 and 35 and disadvantaged persons, face an uncertain economic and financial future. There are approximately 82 million people in this younger generation category alone, many of who are highly unprepared for the financial needs in their future. Macro economic trends, the erosion of traditional private pension schemes and structural weaknesses of public social insurance and healthcare programs suggest a different financial landscape for future generations. This problem is compounded by the fact that many of the younger generation never receive education in personal finance, the use of credit or the long-term benefits of saving. In the U.S. alone, the currently negative national savings rate emphasizes the lack of attention Americans pay to saving and investing for the future. Rather than saving or investing for the future, the younger generation largely spends money for immediate gratification.

As there are an estimated 85 million people over the age of 50 years in the U.S., many of who are more financially secure than their children and grandchildren. At a minimum, government programs like Social Security and Medicare will remain solvent through an older generation's remaining lives. As many in this group are deeply concerned about the social and financial pressures on their offspring who are not able to exceed the standard of living of past generations, there is a high incentive for an older generation to assist in the financial planning of their offspring.

As certain individuals, such as this younger generation, do not think about saving and investing, the available methods for investment and financial planning are ignored. That the U.S. national savings rate would be negative suggests that current efforts to encourage the younger generation to save and invest are defective and that there needs to be a change in strategy.

The traditional methods for investment and financial planning are ineffective in instilling financial values and responsibility in the certain individuals who face an uncertain economic and financial future. In the financial service industry, there exist many over-priced, under-performing investment products which can be very frustrating to younger investors. These methods and products do not provide means in ensuring such investors will adhere to their commitments to investment plans. Neither do these methods and products provide a strong economic and social incentive for the investors to continue investing for the future. As such, there is a need for a system which provides an educational and collaborative approach in assisting and motivating investors with their investment plans.

### SUMMARY OF THE INVENTION

The present invention solves the problems described above. An embodiment of the present invention is a system and method for an automatic wealth transfer mechanism that allows the recipient to receive an education in financial matters as well as a productive savings through collaborative investment and financial planning. In an aspect of the present invention, the savings or financial planning allows for the investor/saver (recipient) to learn the value of thrift and the basics of long-term savings and investment.

In an embodiment, the system and method provides for a commitment between two groups (one the recipient being the investor/saver, the other being, one or more “matchers” or “contributors”) such that both groups contribute to an investment/saving vehicle for the recipient. For example, in an embodiment there is an intergenerational commitment for the investment, such that an older group, more financially secure, commits to investing in savings for a younger recipient; the younger recipient also committing to contributing to the savings. This unique, web-facilitated collaborative method and system provides a vehicle for relatively small investments by several parties to aggregate into a significant stake for the investor (recipient). Further, being web-facilitated, the method and system has the ability to adapt to changes to risk tolerance, investment performance, investment objective/time horizon, and other unknown events.

An embodiment of the present invention is a system providing a central web interface by which users may register for an investment vehicle through an online application, conduct financial planning, and arrange for collaborative investments to be funded.

An embodiment of the present invention receives demographic information from the user through an online form. The user submits his or her personal information and decides whether he or she will be an investor or a matcher. The embodiment provides a subsequent online form tailored to the type of user for the submission of further demographic information. An investor submits his or her financial objective and supplies financial commitment criteria, including the planned monthly contribution and time of commitment, and the source of funds to invest. A matcher or contributor supplies his or her financial commitment criteria, including the planned monthly contribution and time of commitment, and the source of funds to invest.

An embodiment of the present invention allows the investor to select a plurality of matchers/contributors to establish a prospective case or membership for collaborative investment and financial planning.

In another aspect of the present invention, the system provides a further online form for the investor to provide risk tolerance indications. The system determines the investor's risk tolerance. Based on the investor's risk tolerance, financial objective and investment time horizon the system suggests a compatible investment vehicle (e.g. mutual fund, exchange traded fund, or any co-mingled fund).

An embodiment of the present invention allows the investor to select the investment vehicle. Upon affirmation of the investment vehicle by the plurality of matchers, the membership for collaborative investment and financial planning is established where the investor and plurality of matchers agree to contribute a monetary amount to the investment within a predetermined time period.

In an embodiment of the present invention the system provides monitoring of the investor's account through portfolio management software capable of interfacing with the investment vehicle. This may also include progress reports “towards goal,” triggers for modifications and changes, and/or matchers status and readiness to increase or decrease commitment based on milestones of the investor and/or investment performance.

In another embodiment, the system notifies the investor and the matchers of each monthly deposit by email. If any party fails to make the monthly contribution or the investor withdraws from the investment vehicle before the predetermined time period elapses, the present invention informs all parties of the breach of the membership. The parties are given the option to terminate their participation in the membership.

In an embodiment of the present invention the system further sends messages, for instance email messages, covering investment updates and financial topics. In other embodiments, the system provides an end of year report of taxable gains and losses.

According to an embodiment of the present invention there is a method for common financial planning between an investor and one or more contributors, hereinafter collectively referred to as parties, using a web-based system. The method comprises providing an online application to the investor to open one or more investment vehicles and identify the one or more contributors; receiving information from the investor from the application; determining risk-tolerance and investment goals for the investor; recommending one or more investment vehicles utilizing the information and determined risk tolerance; establishing a membership by obtaining an agreement between the parties, wherein the investor agrees to periodically contribute a monetary amount to the one or more investment vehicles, the one or more contributors agree to match the amount or contribute a percentage of the amount, the investor agrees not to withdraw from the one or more investment vehicles in accordance with terms agreed to by the parties; processing periodic payment contributions from the parties based on the agreement amount and purchasing one or more investment vehicles; notifying the parties with a notification when a default in payment contribution by any one of the parties occurs and notifying the one or more matchers when the investor withdraws from the one or more investment vehicles before the predetermined time period ends, wherein the one or more contributors are provided with an option to terminate participation upon receiving the notification.

According to another embodiment of the present invention, there is a computerized system for common financial planning between an investor and one or more contributors, hereinafter collectively referred to as parties, using an intermediary service. The system comprises: a data processing center managed by the intermediary service comprising one or more processors that executes commands to direct operations of the computerized system, a plurality of servers, a plurality of databases, and memory coupled to the one or more processors; a funds transfer mechanism managed by the intermediary service configured to facilitate funds transfer from the parties to one or more investment vehicles; a user interface for providing communication amongst the data processing center, the investor and the contributors over a communication network; an interface between the data processing center and the funds transfer mechanism; and code stored in the memory that directs the one or more processors to: receive information from the investor and identification of the one or more contributors; recommend one or more investment vehicles utilizing the information received from the investor; establish a membership by obtaining an agreement between the parties, wherein the investor agrees to periodically contribute a monetary amount to the one or more investment vehicles, the one or more contributors agree to match the amount or contribute a percentage of the amount, and the investor agrees not to withdraw from the one or more investment vehicles before a predetermined time period ends; process periodic payment contributions from the parties based on the agreement amount and purchase one or more investment vehicles through the funds transfer mechanism; notify the parties with a notification when a default in payment contribution by any one of the parties occurs and notify the one or more contributors when the investor withdraws from the one or more investment vehicles before the predetermined time period ends, wherein the one or more contributors are provided with an option to terminate participation upon receiving the notification.

Implementations of the present invention include a method or process, a system or apparatus, or computer software on a computer-readable medium. These and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 is a block diagram illustrating the concept hardware and software environment according to an embodiment of the present invention as implemented in the form of a public web interface;

FIG. 2 is a block diagram illustrating the concept hardware and software environment according to an embodiment of the present invention as implemented by a private licensee offering a particular investment vehicle for a common investment plan;

FIG. 3 is a flow chart illustrating a method according to an embodiment of the present invention;

FIG. 4 is a flow chart illustrating the concept selection and validation of an investment vehicle, according to an embodiment of the present invention;

FIG. 5 illustrates a processing and transfer of the funds by the system from one account to many brokerage accounts, according to an embodiment of the present invention;

FIG. 6 illustrates a processing and transfer of the funds by the system from many accounts to one brokerage account according to an embodiment of the present invention;

FIG. 7 illustrates a processing and transfer of the funds by the system from many accounts to many brokerage accounts according to an embodiment of the present invention.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. For example, PCs may be replaced with other client communication appliances such as phones, PDA's etc. “Investor, also known as “Saver” may be replaced with a plurality of “Investors/Savers” “Matchers” and “contributors” are included as investors along with the recipient investor. “Matchers” and “contributors” may be used interchangeable and are not limited to a person exactly matching an amount at any certain time, but may contribute any amount at any time. Collectively, investor/saver and matchers/contributors may be referred to as “parties” or “members” when a membership is formed. “Investment vehicle(s)” are also interchangeable with “investment/saving vehicle(s)”. Website names are just used as example embodiments and may be replaced with other websites. “Email” may be replaced with any kind of message communicated by any means.

An embodiment of the present invention is a method and system for establishing a membership for a collaborative investment or investment plan between one or more investors and one or more matchers desiring to aid the investor(s) in reaching their financial objective. In one embodiment of the present invention, the ages of the matchers will be greater than the investor's age. In another embodiment, the investor's age may be in a specified age range and the ages of the matches may be greater by a specified number of years. An object of the invention is to establish an inter-generational commitment to help a younger individual save and invest for the future. In some embodiments, such combinations of matchers and investors might include: grandparents and parents (or other family members) matching the savings of children or grandchildren; families providing a college savings account for a disadvantaged young person in their community; wealthy individuals funding a college or retirement for specific individuals; or a group funding an account for the children of one who died serving the greater public good. The combinations are not limited to the investors and the matchers being related, nor their age relationship.

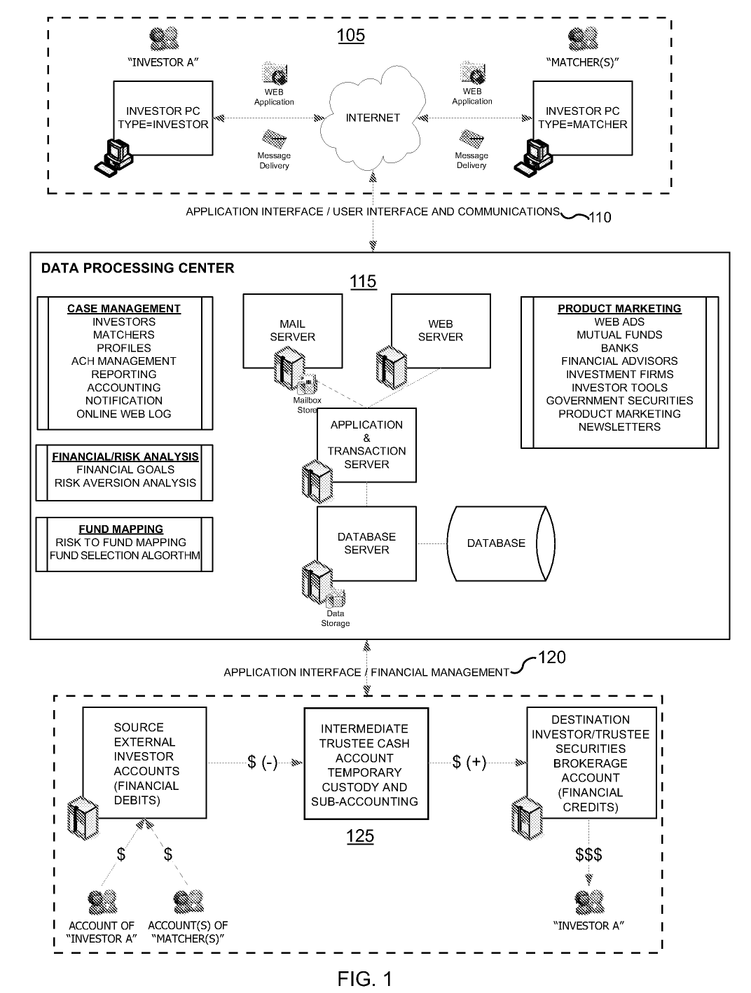

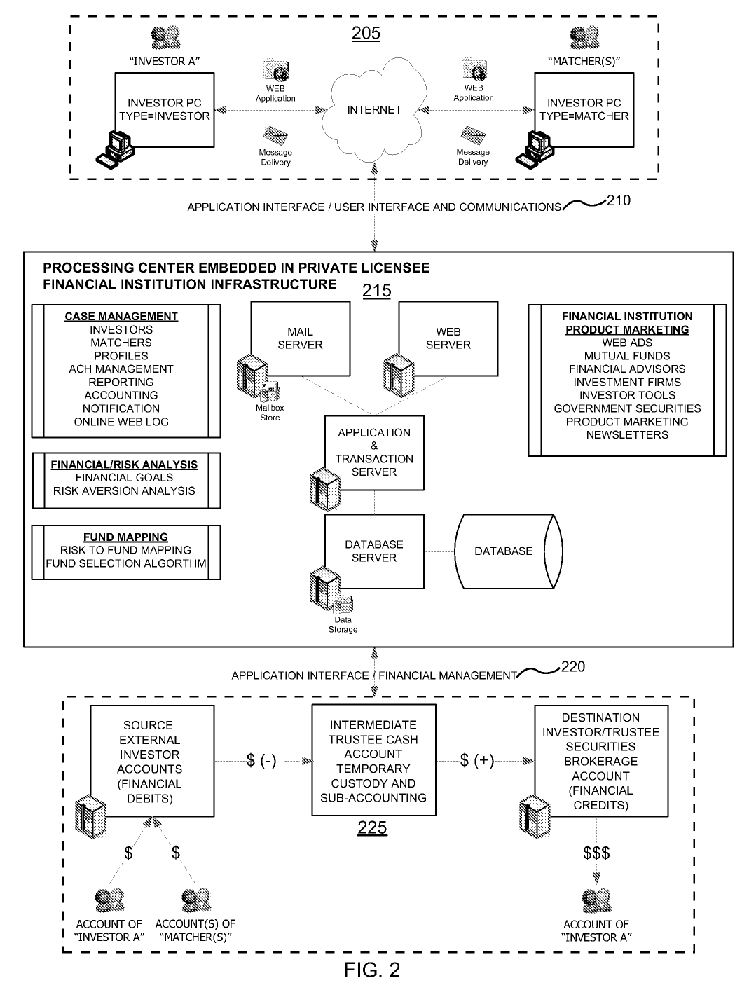

An embodiment of the present invention may be implemented in a system comprising a public web interface as illustrated in FIG. 1. Alternatively, a private licensee wishing to solicit prospective investors and matchers among their existing client base to establish a membership for collaborative investment and/or financial planning using that investment vehicle may implement an embodiment of the present invention as shown in FIG. 2. In either case, an embodiment of the present invention possesses the following attributes described in both FIGS. 1 and 2.

As shown in FIGS. 1 and 2, an embodiment of the present invention includes a central web system 115, 215 which is the data processing center responsible for case or membership management, financial/risk analysis, fund mapping and product marketing. As illustrated, the central web system interface 110, 210, utilizes the Internet to interact and communicate with investors and matchers in facilitating the establishment of the membership and in transmitting various messages 105, 205. As demonstrated, the central system additionally interfaces 120, 220 with the investment vehicle, enabling participating investors to fund the investment vehicle via the Automated Clearing House (ACH) 125, 225, which is a type of investment/savings clearing entity. According to an embodiment of the present invention, the ACH 125, 225 serves as a fund transfer mechanism to facilitate the process of funding an investment/saving vehicle. The ACH process utilizes an intermediary or trustee account to facilitate transfer of funds from debiting account(s) of investors/matchers and crediting the investment/saving vehicle (destination fund account). Further details of the method and system functions follow.

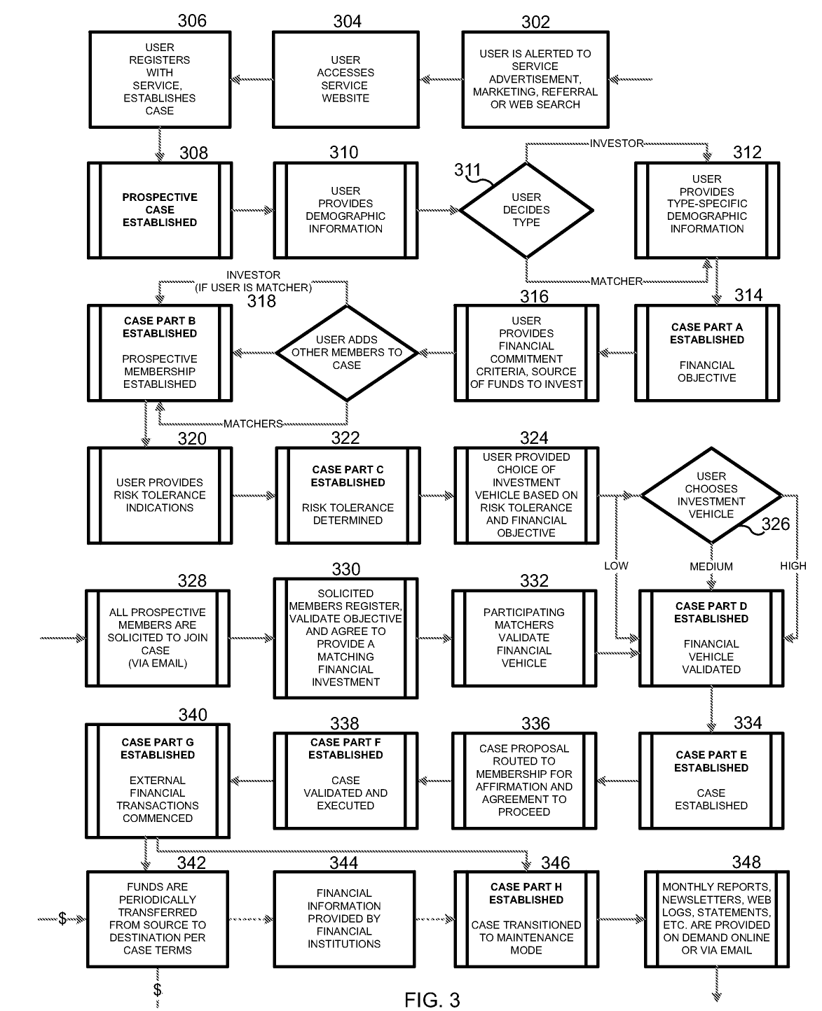

FIG. 3 is a flow chart illustrating a method according to an embodiment of the present invention. The embodiment of the present invention provides a central interface through the Internet 304 by which a user may register for an investment/saving vehicle or more than one investment/saving vehicle, for example, through an online application form 306. A prospective case is thereby established with the system 308. The central interface of the present embodiment provides a subsequent series of online forms for the submission of demographic information 310. The user enters in his or her personal information and determines whether he or she will be an investor or a matcher 311. The central interface provides a following online form tailored to the type of user to receive further demographic information 312. An investor submits his or her financial objective 314 and supplies financial commitment criteria, including the planned monthly contribution and time of commitment, and the source of funds to invest 316. A matcher supplies his or her financial commitment criteria, including the planned monthly contribution and time of commitment, and the source of funds to invest 316. A preferred embodiment of the invention utilizes a database to store the submitted demographic information. As shown in the Appendix, there is described a possible implementation of the database.

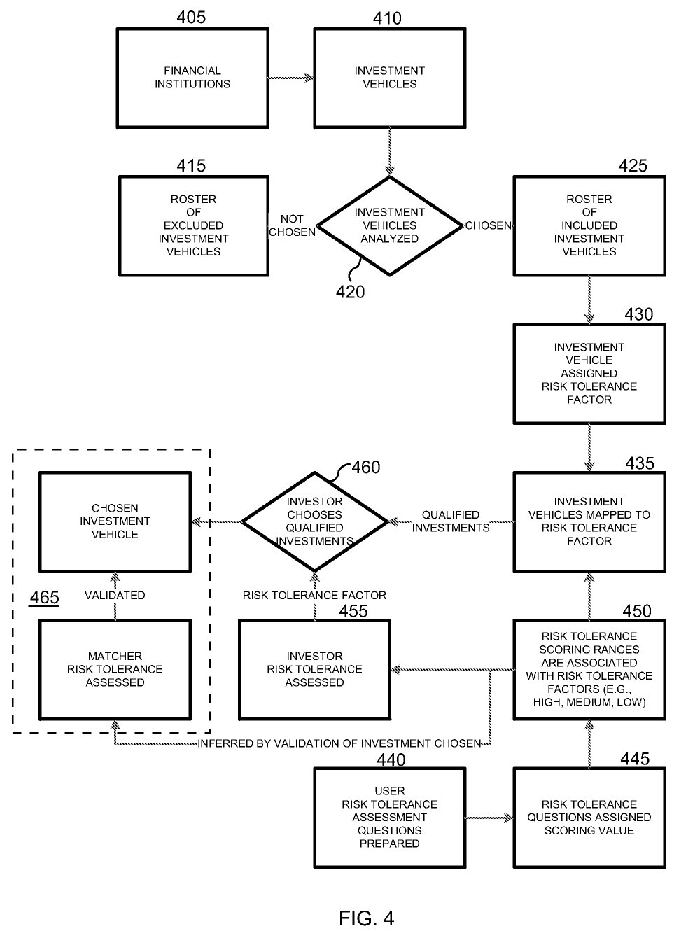

As further described in the method, the user/investor identifies a number of matchers for the establishment of a prospective membership 318 for collaborative investment and/or financial planning. In a preferred embodiment, the investor can specify up to ten matchers. The investor submits risk tolerance indications 320 and the system determines the investor's corresponding risk tolerance 322. Utilizing the investor's risk tolerance and the previously submitted financial objective, a compatible investment vehicle is recommended 324. The investor then selects the investment vehicle 326. This process of selecting the investment vehicle is further detailed in FIG. 4 where a flow chart illustrates the concept of selection and validation of an investment vehicle.

As demonstrated in FIG. 4, the preferred embodiment utilizes a risk assessment questionnaire comprising a series of multiple-choice hypothetical questions 440. Each multiple-choice answer in the question is accorded a particular value equating to specific levels of risk tolerance. The Appendix lists examples of such questions that might be used to determine risk tolerance. The database accepts the answers and tabulates the values to produce a total sum 445. The database compares the sum against predetermined value ranges corresponding to risk tolerance factors such as low risk tolerance, moderate risk tolerance and high risk tolerance 450. As such, a determination is made of the investor's risk tolerance 450. In addition, the system analyzes investment vehicles 420 such that particular investment vehicles are chosen. A roster of included investment vehicles 425 is constructed and each is assigned a risk tolerance 430. The investment vehicles are mapped to the risk tolerance factor 435. Qualified investments are sent on for the investor to choose from 460. In the preferred embodiment, the central interface in a public implementation would provide a website presenting rankings of investment vehicles based on the number of a given investment vehicle purchased for a given risk tolerance and investment time period. The first ranking would display the top 3 funds purchased from the public website and websites of private licensees. Furthermore, a matcher's risk tolerance is also assessed and the matcher validates the investment vehicle chosen by the investor 465. Once matchers validate the investment vehicle, the investment vehicle is part of the case proposal for affirmation and agreement by the membership.

Alternatively, an embodiment of the present invention can be established by a private licensee 215 where the licensee solicits prospective investors and matchers among their existing client base 328 to establish a membership for collaborative investment and/or financial planning using that licensee's investment vehicle 330.

Returning to FIG. 3, any prospective matchers who have not joined the investment plan are solicited by email for instance, to join the investment plan 328. The solicited members register, validate the investor's financial objective and agree to provide a matching or other percentage financial contribution to the investment 330. Once the investor selects an investment vehicle 326, the plurality of matchers review the selection for validation 332, 465. At this point, the matchers have an opportunity to advise and counsel the investor.

Upon validation of the investment vehicle by the matchers, as further demonstrated in FIG. 3, the membership is established 334 where the investor and plurality of matchers agree 336 to contribute a monetary amount to the investment within a predetermined time period and the plan is validated 338. The contribution may be done on a schedule as agreed to by the parties or ad hoc from time to time, whichever applies. Recommendations for investment vehicles may be provided by the system before and/or after a membership has been established and is not limited to occurring at a required time. The processes and steps throughout the system are not limited to the order provided and may by completed without depending upon actions which follow. The object of the present invention is to form a vesting period for the investor to adhere to. Where the parties finally commit to withdrawal from their source accounts, the database and system in the preferred embodiment transmits an email listing the names of the investor and matchers, the amount of the monthly or other timely contribution, the time period of commitment, and a “click here” response.

In an embodiment of the present invention, there is a minimum total monthly contribution and a minimum predetermined time period. For example, in a preferred embodiment, this can be $300 and 3 years.

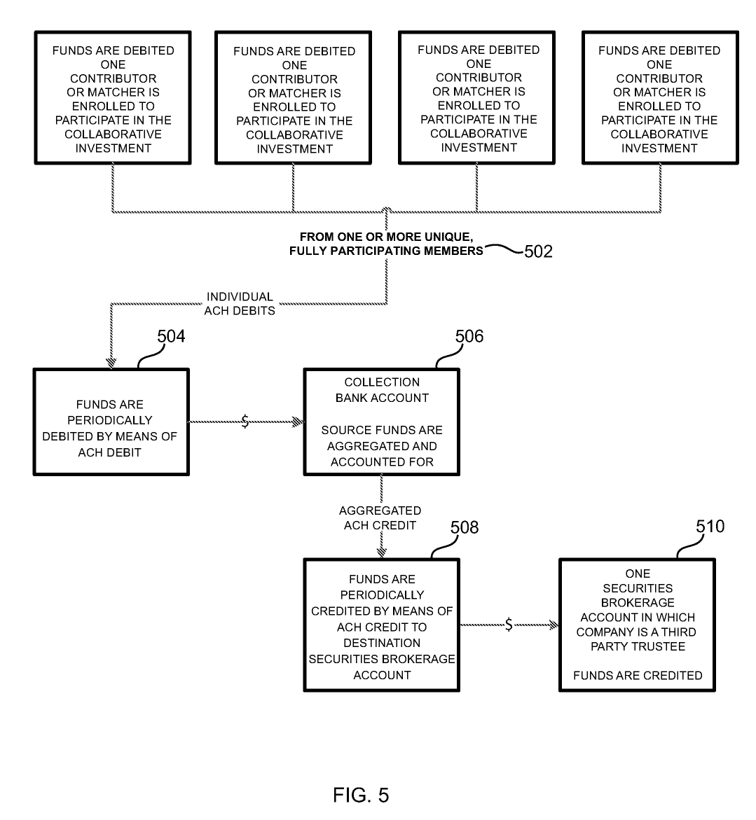

In a further embodiment of the present invention, the system further processes the periodic payment contributions from parties of the established membership 340 and transfers the funds to the appropriate account of the selected investment vehicle 346. The processing and transfer of the funds may be provided in many ways and may occur asynchronously such that instructions to execute transactions are accomplished without affect to the system. For example, the system sends instructions such as a credit or debit transaction to the transfer mechanism (such as ACH), and ACH will independently execute the transaction(s) on behalf of the system. Such transactions may be monitored and validated by the system. As illustrated in FIG. 5, the system allows funds from one or more unique, fully participating members (contributor or matcher) 502 to be transferred and/or aggregated into an intermediary collection account 506. The funds can be individually debited periodically by ACH debit 504, for example, and aggregated and accounted for in the collection account 506. The funds can be periodically transferred/credited by way of ACH credits to a destination securities brokerage account (i.e. the investment/saving vehicle) 508. The system aggregates and provides for crediting the funds in the brokerage account where the owner of the system holds title to the account as a third party trustee 510. As discussed, ACH as an example, is used by the owner of the system (the service) as the means for transferring funds. An agreement is created i) between the system (service) owner and the parties regarding debit transactions and ii) between the system (service) owner and its investment/saving clearing entity regarding credit transactions. These components, together, provide for execution of automated, asynchronous debits from the parties' source financial accounts and credits to one or more destination investment/saving vehicles.

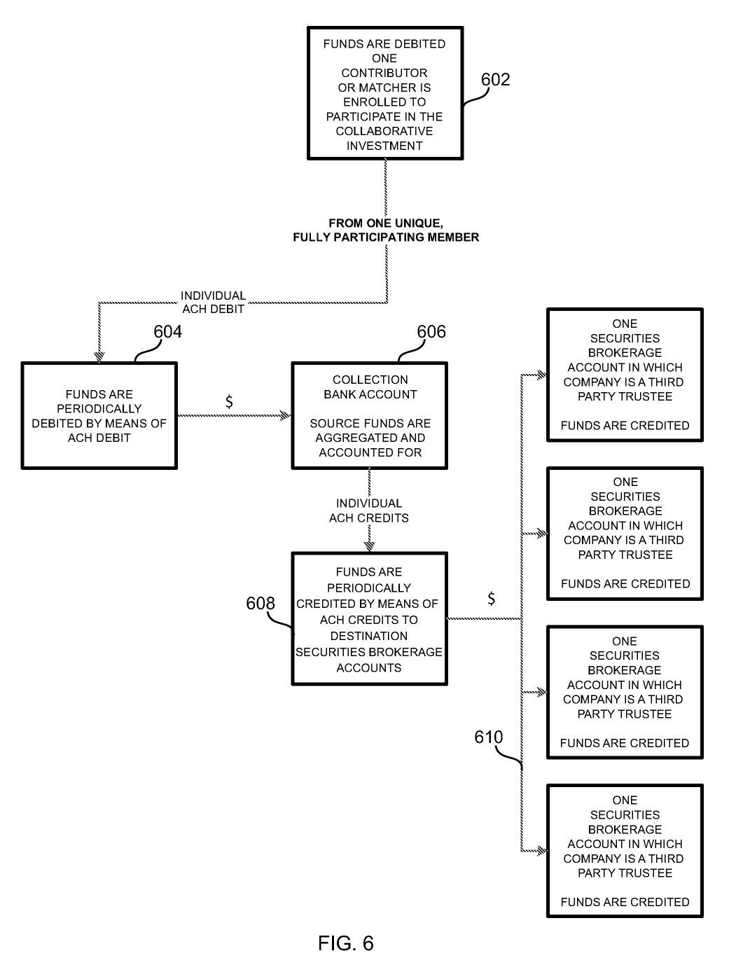

Alternatively, as illustrated in FIG. 6, the system can process funds periodically transferred from a single participating member into separate and distinct investment/saving vehicles. The system aggregates and accounts for the funds periodically transferred from a contributor or matcher 602 into a collection account 606 by means of ACH debits 604. The system then allocates and transfers the aggregated funds into multiple destination brokerage accounts (investment/saving vehicles) as a credit 608, wherein the owner of the system serves in each brokerage account (investment/saving vehicle) as a third party trustee 610.

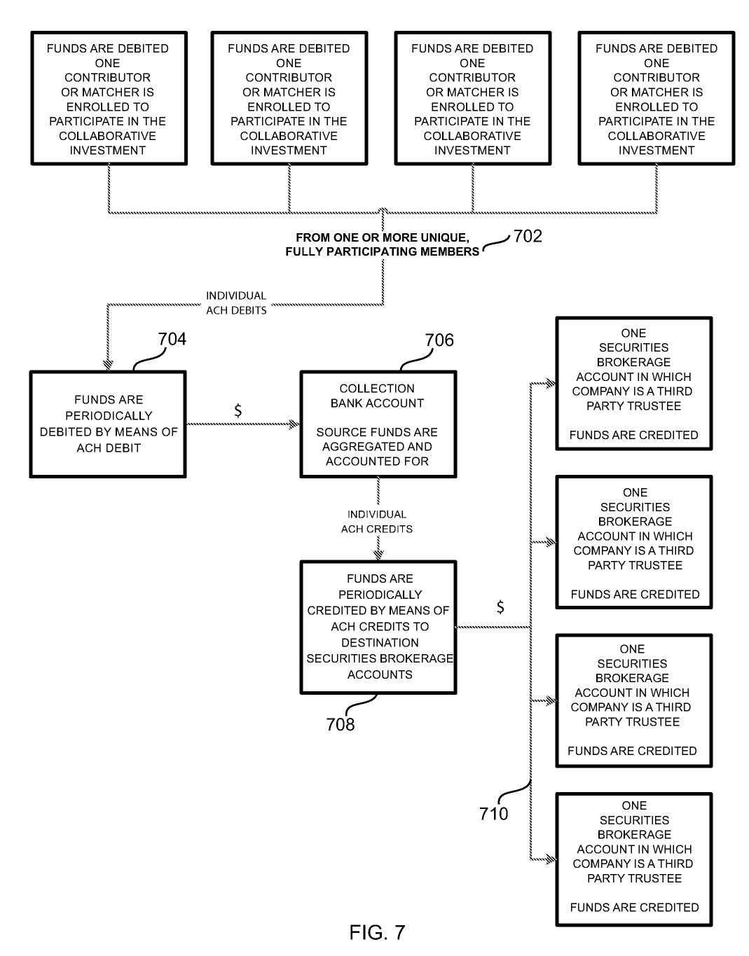

In a further embodiment of the present invention, as illustrated in FIG. 7, the system processes funds from more than one participating member 702 into a plurality of brokerage accounts 710. Similarly, the system via ACH debits the multiple participating member source accounts individually 704, collects the funds into an account for aggregation and accounting 706, credits the multiple destination brokerage accounts 708, to which the owner of the system is a trustee 710.

Alternatively, parties of the membership may transfer funds directly to the appropriate account of the selected investment/savings vehicle 342. In any of these cases, through portfolio management software capable of interfacing with both the customer web interface and the investment vehicle, the system according to an embodiment of the present invention monitors the status of the investor's account on a real time basis. Parties are provided with online monitoring and tracking options such that the status of pending transfers, balances, goal status and other activity may be followed.

In an embodiment of the present invention, the system informs the investor and the matchers of each monthly or timely deposit by email 348. The system provides an “enforcement” of the commitment from all parties to contribute for a specific timeframe. Should any party default in failing to make the monthly contribution or the investor withdraws from the investment/saving vehicle account before the end of the predetermined time period, or as otherwise agreed to, the system and method of the present embodiment immediately notifies all parties of the breach of the membership. Other variations of the enforcement may include a grace period before notification is sent to participants, or also a warning notification to the default party. The parties then have the option of terminating their participation in the membership. In another variation, the party member may select during plan set up, to automatically terminate participation upon default by a party. An object of the present invention is to provide a strong economic and social incentive for the investor to continue saving and investing for the future.

Essentially, by the mutually agreed upon timeframe and commitment by the parties, a vesting period is formed in which the investor must adhere to reach both savings and investment goals and to also maintain a matching by those agreeing to match the contribution.

In a further embodiment of the present invention, the system transmits messages, such as email messages, covering investment updates and financial topics 348. In the present embodiment the parties of the membership may also access the investor's account information on demand online. An object of the present invention is to change the investor's saving and investing habits. For example, the database in the preferred embodiment transmits to investors and matchers, weekly messages relating to financial and investment topics and monthly email newsletters showing account information and investment insights. The system may also provide end of year reporting of taxable gains and losses. The database allows matchers to opt out from the delivery of the weekly or monthly messages. Investors may opt out from the monthly messages, but the weekly messages may be made a requirement as a condition of membership.

As a further embodiment of the business system of the present invention, the investment plan is marketed to the older generation who would subsequently encourage those of the younger generation to consider the investment plan. In the present embodiment, marketing can target the audience of magazines, websites and radio programs geared towards the older generation. For example, such magazines include Reader's Digest, Modern Maturity (the AARP monthly) and National Geographic; such websites include Web MD and Third Age; and such radio programs include Paul Harvey.

According to an embodiment of the present invention, an investment vehicle may utilize demographic data for its existing client base in advertising its investment plan.

As part of the business system, in a further embodiment of the present invention, the system provides quality investment management and savings advice at a fee structure below other alternatives. An object of the present invention is to help investors avoid over-priced, under-performing investment products prevalent in the financial service industry. A lower annual fee, for example, an annual fee of 0.20% of the investor's account value may be applied to management fees for the service utilizing the system. This annual fee could be subtracted directly from the investor's account or paid by the investment vehicle(s) directly to the service utilizing the system at the discretion of the investment vehicle. In other examples, if the fees may be withdrawn directly from the investor's account, at the end of every quarter, the management fees would be charged against the investment vehicle's account at time of monthly deposit and may be electronically credited to the service's banking account. If the management fees were paid directly by the investment vehicle, the investment vehicle would be billed every month.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments of the foregoing description.

We claim:

1. A method for common financial planning between an investor and one or more contributors, hereinafter collectively referred to as parties, using a web-based system, the method comprising:
providing an online application to the investor to open one or more investment vehicles and identify the one or more contributors;
receiving information from the investor from the application;
determining risk-tolerance and investment goals for the investor;
recommending one or more investment vehicles utilizing the information and determined risk tolerance;
establishing a membership by obtaining an agreement between the parties, wherein the investor agrees to periodically contribute a monetary amount to the one or more investment vehicles, the one or more contributors agree to match the amount or contribute a percentage of the amount, the investor agrees not to withdraw from the one or more investment vehicles in accordance with terms agreed to by the parties;
processing periodic payment contributions from the parties based on the agreement amount and purchasing one or more investment vehicles;
notifying the parties with a notification when a default in payment contribution by any one of the parties occurs and notifying the one or more matchers when the investor withdraws from the one or more investment vehicles before the predetermined time period ends, wherein the one or more contributors are provided with an option to terminate participation upon receiving the notification.

2. The method for common financial planning according to claim 1, further comprising sending requests to the one or more contributors identified by the investor, to join the membership.

3. The method for common financial planning according to claim 1, further comprising receiving other information from the one or more contributors to be utilized in the recommending one or more investment vehicles.

4. The method for common financial planning according to claim 1, wherein the investor selects an investment vehicle that is validated by the contributors of the membership.

5. The method for common financial planning according to claim 1, wherein the investor agrees to periodically contribute a monetary amount to the one or more investment vehicles for a predetermined time period.

6. The method for common financial planning according to claim 1, wherein the investor agrees not to withdraw from the one or more investment vehicles before a predetermined time period ends.

7. The method for common financial planning according to claim 1, wherein processing periodic payment contributions comprises debiting a source account belonging to the investor, aggregating the contributions in an intermediary collection account, and crediting the one or more investment vehicles of which an owner of the system is a trustee.

8. The method for common financial planning according to claim 1, wherein processing periodic payment contributions comprises debiting a source account belonging to the investor and debiting at least one source account belonging to the one or more contributors, aggregating the contributions in an intermediary collection account, and crediting the one or more investment vehicles of which an owner of the system is a trustee.

9. The method for common financial planning according to claim 1, further comprising notifying the parties of each timely contribution made to the one or more investment vehicles.

10. A method for common financial planning between an investor and one or more contributors, hereinafter collectively referred to as parties, using a web-based system, the method comprising:
receiving information from the investor to open one or more investment vehicles and recommending one or more investment vehicles;
establishing a membership by obtaining an agreement between the parties, wherein the investor agrees to periodically contribute a monetary amount to the one or more investment vehicles, the one or more contributors agree to match the amount or contribute a percentage of the amount, the investor agrees not to withdraw from the one or more investment vehicles before a predetermined time period ends;
processing payment contributions from the parties based on the agreement amount and purchasing one or more investment vehicles;
notifying the parties with a notification when a default in payment contribution by any one of the parties occurs and notifying the one or more matchers when the investor withdraws from the one or more investment vehicles before the predetermined time period ends, wherein the one or more contributors are provided with an option to terminate participation.

11. The method according to claim 10, wherein the contributors are solicited to participate in the membership by the investor.

12. A computerized system for common financial planning between an investor and one or more contributors, hereinafter collectively referred to as parties, using an intermediary service, the system comprising:
a data processing center managed by the intermediary service comprising one or more processors that executes commands to direct operations of the computerized system, a plurality of servers, a plurality of databases, and memory coupled to the one or more processors;
a funds transfer mechanism managed by the intermediary service configured to facilitate funds transfer from the parties to one or more investment vehicles;
a user interface for providing communication amongst the data processing center, the investor and the contributors over a communication network;
an interface between the data processing center and the funds transfer mechanism; and
code stored in the memory that directs the one or more processors to:
receive information from the investor and identification of the one or more contributors;
recommend one or more investment vehicles utilizing the information received from the investor;
establish a membership by obtaining an agreement between the parties, wherein the investor agrees to periodically contribute a monetary amount to the one or more investment vehicles, the one or more contributors agree to match the amount or contribute a percentage of the amount, and the investor agrees not to withdraw from the one or more investment vehicles before a predetermined time period ends;
process periodic payment contributions from the parties based on the agreement amount and purchase one or more investment vehicles through the funds transfer mechanism;
notify the parties with a notification when a default in payment contribution by any one of the parties occurs and notify the one or more contributors when the investor withdraws from the one or more investment vehicles before the predetermined time period ends, wherein the one or more contributors are provided with an option to terminate participation upon receiving the notification.

13. The system for common financial planning according to claim 12, wherein the code further directs the one or more processors to determine risk-tolerance and investment goals for the investor based on the information received from the investor.

14. The system for common financial planning according to claim 12, wherein the code further directs the one or more processors to send requests to the one or more contributors identified by the investor, to join the membership.

15. The system for common financial planning according to claim 12, wherein the code further directs the one or more processors to receive other information from the one or more contributors to be utilized in the recommending one or more investment vehicles.

16. The system for common financial planning according to claim 12, wherein the investor selects an investment vehicle that is validated by the contributors of the membership.

17. The system for common financial planning according to claim 12, wherein the code further directs the one or more processors to notify the investor and one or more contributors of each timely contribution made to the one or more investment vehicles.

18. The system for common financial planning according to claim 12, wherein the funds transfer mechanism transfers funds via a trustee collection account managed by the intermediary service.

19. The system for common financial planning according to claim 18, wherein the funds transfer mechanism is configured to debit a source account belonging to the investor, aggregate the contributions in the collection account and credit the one or more investment vehicles of which the intermediary service is a trustee.

20. The system for common financial planning according to claim 18, wherein the funds transfer mechanism is configured to debit a source account belonging to the investor and debit at least one source account belonging to the one or more contributors, aggregate the contributions in the collection account, and credit the one or more investment vehicles of which the intermediary service is a trustee.
